(19) United States
(12) Patent Application Publication
(10) Pub. No.: US 2008/0165127 A1
(43) Pub. Date: Jul. 10, 2008

(54) SLIDING INPUT DEVICE AND INPUT METHOD

(75) Inventor: Ju-il Eom, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/843,326

(22) Filed: Aug. 22, 2007

(30) Foreign Application Priority Data
Jan. 10, 2007 (KR) 10-2007-0003083

(51) Int. Cl. G06F 3/033; G09G 5/00

(52) U.S. Cl. 345/161; 345/156

(57) ABSTRACT

A sliding input device and an input method are provided. The input method using the input device includes: moving an upper plate and a stick unit fixed to the upper plate when force is exerted on the upper plate; sensing movements of the stick unit along guide lines provided in a lower plate, and generating directional key signals corresponding to the movements. Accordingly, a user can input up, down, left, and right directional information by manipulating the upper plate by pushing or pulling the upper plate in a plane, without pushing buttons. Therefore, the user can easily and rapidly perform desired manipulation, and the user can have fun while manipulating the input device to input the directional information.

### CROSS-REFERENCE TO RELATED PATENT APPLICATIONS

This application claims priority from Korean Patent Application No. 10-2007-0003083, filed on Jan. 10, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to an input method and, more particularly, to a sliding input method and device.

2. Description of the Related Art

Portable devices such as MP3 players, portable multimedia players (PMPs), personal digital assistants (PDAs), and ultra-mobile personal computers (UMPCs) are becoming more and more popular.

These devices become smaller with the development of electronic integration technology. However, as many functions are provided in a small device, the user interface, such as buttons, becomes more complex.

For example, when a number of small buttons is used, there is the inconvenience of visibly checking to press the correct button, and when the button layout is not intuitive, a user may have to spend time learning to control the device.

Other problems include the fact that due to the number of buttons, the complexity of the physical user interface (PUI) increases, and when a portable device has a large number of buttons its structure becomes complex.

### SUMMARY OF THE INVENTION

Exemplary embodiments of the present invention provide an input device and an input method used to intuitively and effectively manipulate a portable device by reducing the complexity of a user interface of the portable device.

An aspect of the present invention is to provide a sliding input device comprising: an upper plate, a lower plate having guide lines in four directions of up, down, left and right, a stick unit which is fixed to the upper plate and moves along the guide lines of the lower plate by a force exerted on the upper plate, and a sensing unit, which is provided in the lower plate, senses movements of the stick unit, and generates input signals corresponding to the movements.

Another aspect of the present invention is to provide an input method using an input device including an upper plate, a lower plate having guide lines in four directions of up, down, left and right, and a stick unit located in the lower plate and fixed to the upper plate, the input method comprising: moving the upper plate and the stick unit when force is exerted on the upper plate, sensing movements of the stick unit along the guide lines in the lower plate, and generating directional key signals corresponding to the movements.

### BRIEF DESCRIPTION OF THE DRAWINGS

The above and other features and advantages of the present invention will become more apparent by describing in detail exemplary embodiments thereof with reference to the accompanying drawings, in which:

FIGS. 1A and 1B show a sliding input device according to an exemplary embodiment of the present invention;

FIG. 2A shows a related art stick and FIG. 2B shows an example of a stick unit shown in FIG. 1;

FIG. 3 shows an example of a lower plate and the stick unit shown in FIG. 1;

FIG. 4 is a block diagram showing a structure of a sliding input device according to an exemplary embodiment of the present invention;

FIG. 5A shows an example of movements of the stick unit shown in FIG. 1;

FIG. 5B shows an example in which a user moves an upper plate to the left;

FIG. 6 is a flowchart showing an input method using an input device according to an exemplary embodiment of the present invention;

FIG. 7 shows control operations of a controller according to an input provided to an input device in a search mode state according to an exemplary embodiment of the present invention;

FIGS. 8A-8E show an example of operations of a display unit according to an input provided to an input device in a search mode; and

FIGS. 9A-9G show an example of operations of a display unit according to an input provided to input device in a play mode.

### DETAILED DESCRIPTION OF EXEMPLARY EMBODIMENTS OF THE INVENTION

Exemplary embodiments of the present invention will now be described in detail with reference to the accompanying drawings.

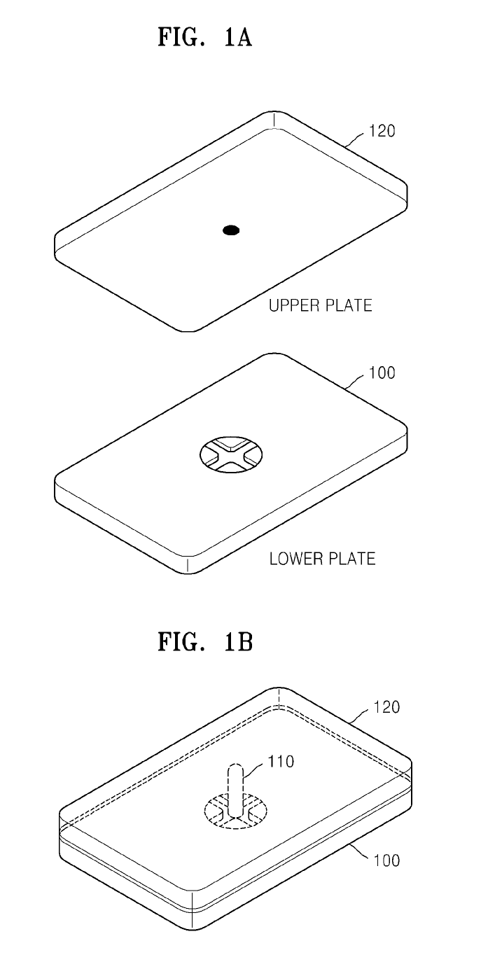

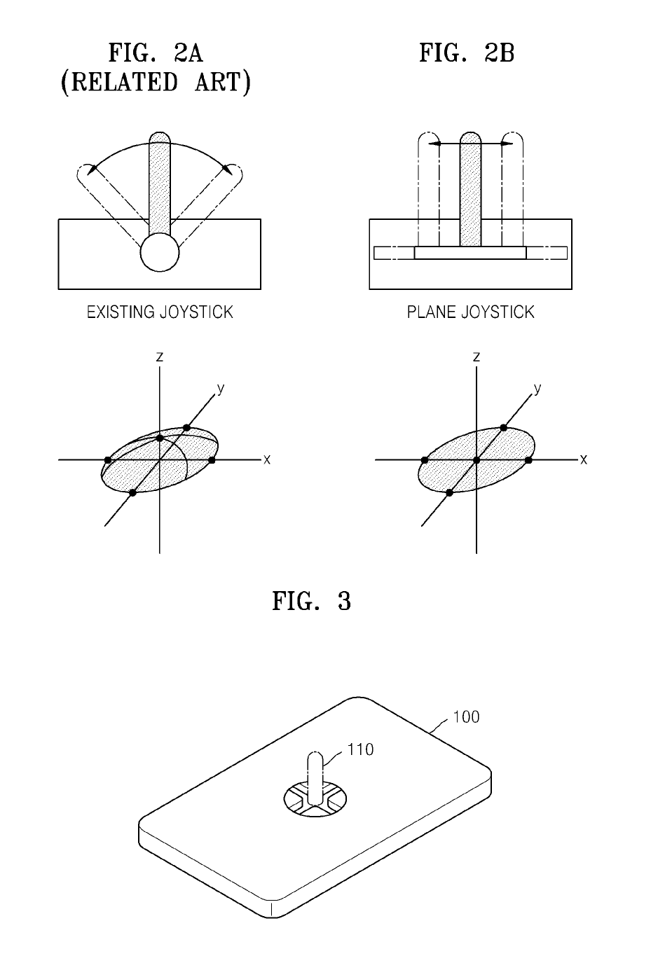

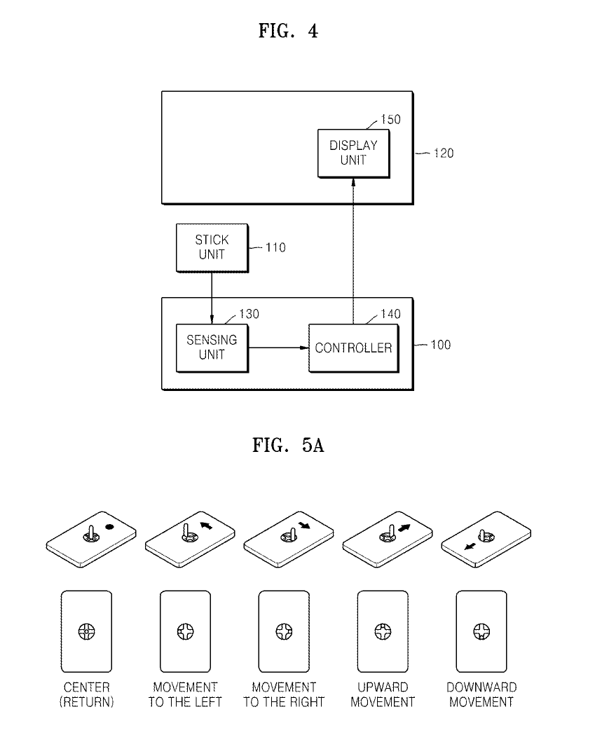

FIGS. 1A and 1B show the structure of a sliding input device according to an exemplary embodiment of the present invention. FIGS. 2B and 3 show the shapes of a stick unit and a lower plate and their engagement according to an exemplary embodiment of the present invention. FIG. 4 is a block diagram showing the structure of the sliding input device according to an embodiment of the present invention.

The sliding input device according to an exemplary embodiment of the present invention will be described with reference to FIGS. 1, 2B, 3 and 4.

Referring to FIGS. 1A and 1B, the input device according to an exemplary embodiment of the present invention includes the lower plate 100, the stick unit 110, and an upper plate 120. In addition, as shown in FIG. 4, the lower plate 100 includes a sensing unit 130 and a controller 140, and the upper plate 120 includes a display unit 150.

The upper plate 120 is constructed to be able to slide up, down, left, and right with respect to the lower plate 100.

For this, as shown in FIGS. 2A and 2B, unlike an existing joystick, the stick unit 110 can be movable only in a plane with respect to the lower plate 100, and as shown in FIG. 3, up, down, left, and right guide lines are formed on the lower plate 100, so that the stick unit 110 can move in the four directions of up, down, left, and right along the guide lines. In addition, the stick unit 110 is fixed to the upper plate 120, so that the stick unit 110 moves together with the upper plate 120.

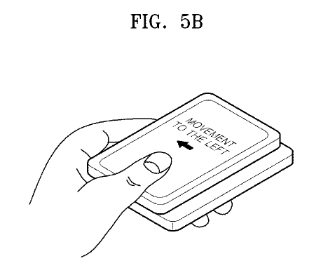

FIG. 5A shows an example of movements of the stick unit 110 with respect to the lower plate 100, showing the stick unit 110 at the center, moved to the left, moved to the right, moved upward, and moved downward.

Accordingly, the upper plate 120 and the stick unit 110 can move only in the four directions of up, down, left, and right along the guide lines, and the sensing unit 130 in the lower plate 100 senses the movements of the stick unit 110. As another example, the sensing unit 130 can be mounted on the stick unit 110.

The sensing unit 130 senses the movements of the stick unit 110, generates directional key signals according to the movements, and transmits the directional key signals to the controller 140. The directional key signals include up, down, left, and right directional key signals.

The controller 140 operates according to the directional key signals transmitted from the sensing unit 130. With reference to instructions stored in a memory (not shown), the controller 140 receives the directional key signals transmitted from the sensing unit 130 and controls various operations as described later or transmits information to the display unit 150 so as to allow the display unit 150 to display information to a user.

According to an exemplary embodiment of the present invention, the user manipulates the upper plate 120 by pulling or pushing in one plane so as to input up, down, right, and left direction information, and the user can have fun while manipulating the input device to input the direction information.

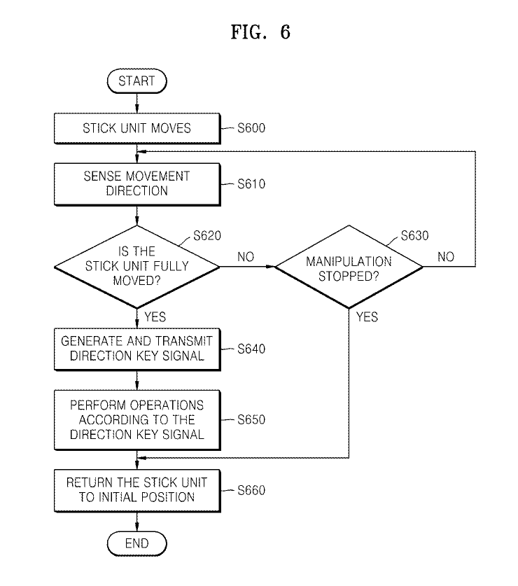

FIG. 6 shows an example of an input method using the input device according to an exemplary embodiment of the present invention. The input method using the input device according to an exemplary embodiment of the present invention will be described in detail with reference to FIG. 6.

When the user pushes the upper plate 120 up, down, right, or left, for example, to the left as shown in FIG. 5B, since the stick unit 110 is fixed to the upper plate 120, the stick unit 110 also moves to the left with respect to the lower plate 100, and the sensing unit 130 senses the movement of the stick unit 110, generates a left directional key signal, and transmits the signal to the controller 140.

An exemplary embodiment of the aforementioned operations is as follows.

When the user pushes the upper plate 120 to the left, since the stick unit 110 is fixed to the upper plate 120, the stick unit 110 moves to the left with respect to the lower plate 100 (operation S600).

The sensing unit 130 then senses that the stick unit 110 moves to the left (operation S610) and detects whether the stick unit 110 moves fully to the left (operation S620).

When the stick unit 110 does not move fully, the sensing unit 130 senses whether the user has stopped manipulating (operation S630). When the user has not stopped manipulating, the sensing unit 130 returns to operation S610 to sense a movement of the stick unit 110. When the user stops manipulating in operation S630, the stick unit 110 is returned to its initial position in the center (operation S660), and the operations are terminated. A spring member (not shown) may be used to return the stick unit 110 to its initial position.

When the stick unit 110 moves fully in operation S620, the sensing unit 130 generates the left directional key signal and transmits the signal to the controller 140 (operation S640).

The controller 140 operates according to the directional key signal, provides information to the display unit 150 so as to display the information to the user (operation S650), returns the stick unit 110 to the center (operation S660), and terminates the operations.

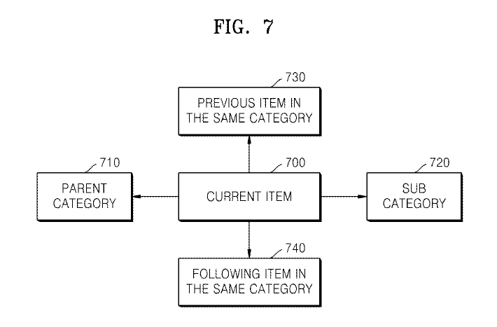

FIG. 7 shows the controller 140 of the input device in a search mode according to an exemplary embodiment of the present invention. The operation of the controller 140 according to an input provided in a search mode according to an exemplary embodiment of the present invention is described as follows.

First, in the search mode, it is assumed that an item 700 is activated.

When the user manipulates the upper plate 120 to the left, the stick unit 110 moves to the left, and the sensing unit 130 generates the left directional key signal. The controller 140 receives the left directional key signal and activates a parent category 710 including the current item.

When the user manipulates the upper plate 120 to the right, the stick unit 110 moves to the right, and the sensing unit 130 generates a right directional key signal. The controller 140 receives the right directional key signal and activates a sub category 720 included in the current item.

When the user manipulates the upper plate 120 upward, the stick unit moves upward, and the sensing unit 130 generates an up directional key signal. The controller 140 receives the up directional key signal and actives the previous item 730 in the same category.

When the user manipulates the upper plate 120 downward, the stick unit 110 moves downward, and the sensing unit 130 generates a down directional key signal. The controller 140 receives the down directional key signal and actives the following item 740 in the same category.

When the user keeps the upper plate 120 moved to the left, the sensing unit 130 continuously inputs the left directional key signal to the controller 140, and the controller 140 receiving the signal sequentially activates parent categories including the current item to move rapidly and continuously through the parent categories.

When the user keeps the upper plate 120 moved upward, the sensing unit 130 continuously inputs the up directional key signal to the controller 140, and the controller 140 receiving the signal sequentially activates previous items in the same category to move rapidly and continuously through the previous items.

When the user keeps the upper plate 120 moved downward, the sensing unit 130 continuously inputs the down directional key signal to the controller 140, and the controller 140 receiving the signal sequentially activates following items in the same category to move rapidly and continuously through the following items.

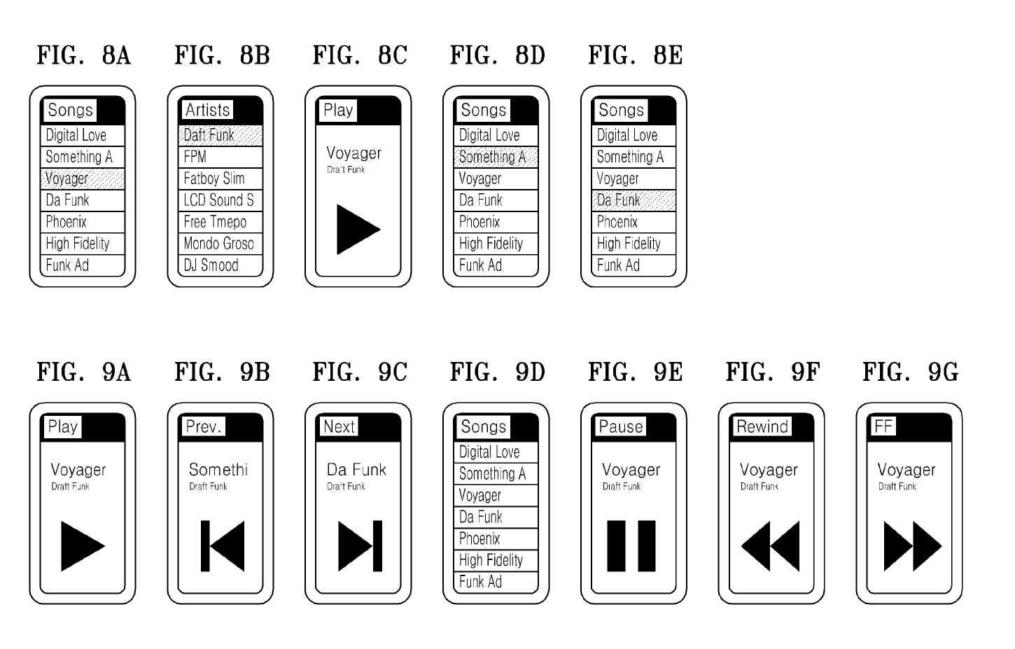

FIGS. 8A-8E show an example in which the display unit 150 displays information according to an input of the input device in the search mode according to an exemplary embodiment of the present invention. An example of the operation of the controller 140 according to an input and states of the display unit 150 according to the operations in the search mode for a current song is described with reference to FIGS. 8A-8E.

First, in the search mode, as shown in FIG. 8A, it is assumed that “Voyager” is activated as the current corresponding song.

When the user manipulates the upper plate 120 to the left, the stick unit 110 moves to the left, and the sensing unit 130 generates the left directional key signal. The controller 140 receives the left directional key, actives ‘Daft Punk’ which is a parent category including the current song ‘Voyager’, and allows the display unit 150 to display the parent category as shown in FIG. 8B in order to inform the user that the parent category ‘Daft Punk’ is activated.

When the user manipulates the upper plate 120 to the right, the stick unit 110 moves to the right, and the sensing unit 130 generates the right direction key signal. The controller 140 receives the right direction key signal, plays the current song ‘Voyager’ in a play mode, and allows the display unit 150 to display the song as shown in FIG. 8C in order to inform the user that the song is currently being played.

When the user manipulates the upper plate 120 upward, the stick unit 110 moves upward, and the sensing unit 130 generates the up directional key signal. The controller 140 receives the up directional key signal, activates the previous song ‘Something About Us’ in the same category, and allows the display unit 150 to display the previous song as shown in FIG. 8D in order to inform the user that the previous song ‘Something About Us’ is activated.

When the user manipulates the upper plate 120 downward, the stick unit 110 moves downward, and the sensing unit 130 generates the down directional key signal. The controller 140 receives the down directional key signal, activates a next song ‘Da Funk’ in the same category, and allows the display unit 150 to display the next song as shown in FIG. 8E in order to inform the user that the next song ‘Da Funk’ is activated.

When the user keeps the upper plate 120 moved to the left, the sensing unit 130 continuously inputs the left directional key signal to the controller 140, and the controller 140 receiving the signal sequentially activates the parent categories of the current song. Accordingly, the user can rapidly search for a desired parent category.

When the user keeps the upper plate 120 moved upward, the sensing unit 130 continuously inputs the up directional key signal to the controller 140, and the controller 140 receiving the signal activates the previous song in the same category as the current song. Accordingly, the user can rapidly search for a desired previous song before the current song.

When the user keeps the upper plate 120 moved downward, the sensing unit 130 continuously inputs the down directional key signal to the controller 140, and the controller 140 receiving the signal sequentially actives the following songs in the same category as the current song. Accordingly, the user can rapidly search for a desired song following the current song.

FIGS. 9A-9G show an example in which the display unit 150 displays information according to an input of the input device when the current song is played according to an exemplary embodiment of the present invention. An exemplary embodiment of the operation of the controller 140 and the state of the display unit 150 when the current song is played is described with reference to FIGS. 9A-9G.

First, the current song ‘Voyager’ is played, as shown in FIG. 9A.

When the user manipulates the upper plate 120 to the left, the stick unit 110 moves to the left, and the sensing unit 130 generates the left directional key signal. The controller 140 receiving the left direction key plays the previous song ‘Something About Us’ in the same category and allows the display unit 150 to display an image as shown in FIG. 9B in order to inform the user that the previous song ‘Something About Us’ is being played.

When the user manipulates the upper plate 120 to the right, the stick unit 110 moves to the right, and the sensing unit 130 generates the right directional key signal. The controller receiving the right direction key signal starts to play the next song ‘Da Funk’ in the same category and allows the display unit 150 to display an image as shown in FIG. 9C in order to inform the user that the next song ‘Da Funk’ is being played.

When the user manipulates the upper plate 120 upward, the stick unit 110 moves upward, and the sensing unit 130 generates the up directional key signal. The controller 140 receiving the up directional key signal allows the display unit 150 to display songs included in a category including the current playing song as shown in FIG. 9D in order to provide the search mode to the user.

When the user manipulates the upper plate 120 downward, the stick unit 110 moves downward, the sensing unit 130 generates the down directional key signal. The controller 140 receiving the down direction key signal stops playing and allows the display unit 150 to display an image as shown in FIG. 9E in order to inform the user that playback has stopped.

When the user keeps the upper plate 120 moved to the left, the sensing unit 130 continuously inputs the left directional key signal to the controller 140, and the controller 140 receiving the signal rewinds the current song and allows the display unit 150 to display an image as shown in FIG. 9F in order to inform the user of the rewind operation. When the upper plate 120 is returned to the center and the left directional key signal is no longer input to the controller 140, playback is resumed at the new time point.

When the user keeps the upper plate 120 moved to the right, the sensing unit 130 continuously inputs the right directional key signal to the controller 140, and the controller 140 receiving the signal fast forwards the current song and allows the display unit 150 to display an image as shown in FIG. 9G in order to inform the user of the fast forward operation. When the upper plate 120 is returned to the center and the right directional key signal is no longer input to the controller 1410, playback is resumed at the new time point.

Consistent with the present invention, the user manipulates a portable device such as an MP3 player by pulling or pushing an upper plate in one plane in order to input up, down, left, and right directional information without pressing buttons. Therefore, the number of buttons can be reduced, and buttons may not be needed at all, so that the user can easily and rapidly control the device without needing to look for buttons, and the user can have fun while manipulating the input device to input the directional information.

In addition, the number of buttons is reduced, simplifying the structure of the portable device.

The exemplary embodiments of the present invention can be written as computer programs, that can be executed in a computer or in a portable device such as an MP3 player, and can be implemented in general-use digital computers that execute the programs using a portable device or computer readable recording medium. A data structure used in the exemplary embodiments of the present invention can be recorded through various means in a portable device or computer readable recording medium.

Examples of the portable device or computer readable recording medium include storage media used in the portable device (e.g. firmware and flash memories, etc), magnetic storage media (e.g., ROM, floppy disks, hard disks, etc.), optical recording media (e.g., CD-ROMs, or DVDs), and storage media such as carrier waves (e.g., transmission through the Internet).

While the present invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A sliding input device comprising:
an upper plate;
a lower plate having guide lines in four directions of up, down, left, and right;
a stick unit which is fixed to the upper plate and moves along the guide lines of the lower plate by a force exerted on the upper plate; and
a sensing unit, which is provided in the lower plate, senses movements of the stick unit, and generates input signals corresponding to the movements.

2. The input device of claim 1, wherein the upper plate comprises a display unit for displaying information on the input signals generated by the sensing unit to a user.

3. The input device of claim 1, wherein when the force exerted on the upper plate is removed, the stick unit returns to an initial position.

4. The input device of claim 1, wherein the input signals are directional key signals corresponding to the movements of the stick unit.

5. The input device of claim 4, further comprising a controller which receives the directional key signals generated by the sensing unit and operates according to the directional key signals.

6. The input device of claim 5, wherein the sensing unit generates an up directional key signal by sensing that the stick unit moves upward, generates a down directional key signal by sensing that the stick unit moves downward, generates a left directional key signal by sensing that the stick unit moves to the left, and generates a right directional key signal by sensing that the stick unit moves to the right.

7. The input device of claim 6, wherein in a search mode in which a current item is activated, the controller activates a previous item in the same category as the current item when the up directional key signal is input, actives a following item in the same category as the current item when the down directional key signal is input, actives a parent category including the current item when the left directional key signal is input, and activates a sub category included in the current item when the right directional key signal is input.

8. The input device of claim 6, wherein in the search mode in which a current item is activated, the controller sequentially activates previous items in the same category as the current item when the up directional key signal is continuously input, sequentially activates following items in the same category as the current item when the down directional key signal is continuously input, and sequentially activates parent categories of the current item when the left directional key signal is continuously input.

9. The input device of claim 6, wherein in a search mode in which a current song is activated, the controller activates a previous song in the same category as the current song when the up directional key signal is input, activates a following song in the same category as the current song when the down directional key signal is input, activates a parent category including the current song when the left directional key signal is input, and activates the current song when the right directional key signal is input.

10. The input device of claim 6, wherein in the search mode in which the current song is activated, the controller sequentially activates previous songs in the same category as the current song when the up directional key signal is continuously input, sequentially activates following songs in the same category as the current song when the down directional key signal is continuously input, and sequentially activates parent categories of the current song when the left directional key signal is continuously input.

11. The input device of claim 6, wherein in the search mode in which the current song is played, the controller allows songs in a category including the current song to be displayed when the up directional key signal is input, stops playing the current song when the down directional key signal is input, starts playing a previous song in the same category as the current song when the left directional key signal is input, and starts playing a following song in the same category as the current song when the right directional key signal is input.

12. The input device of claim 11, wherein in the search mode in which the current song is played, the controller rewinds the current song when the left directional key signal is continuously input and fast forwards the current song when the right directional key signal is continuously input.

13. The input device of claim 7, wherein the upper plate comprises a display unit which displays information of the controller.

14. An input method using an input device including an upper plate, a lower plate having guide lines in four directions of up, down, left, and right, and a stick unit located in the lower plate and fixed to the upper plate, the input method comprising:
(a) moving the upper plate and the stick unit when force is exerted on the upper plate;
(b) sensing movements of the stick unit along the guide lines in the lower plate; and
(c) generating directional key signals corresponding to the movements.

15. The input method of claim 14, further comprising returning the stick unit to an initial position when the force exerted on the upper plate is removed.

16. The input method of claim 14, further comprising (d) performing operations according to the input directional key signals when the directional key signals are input.

17. The input method of claim 16, wherein in (c), an up directional key signal is generated when sensing that the stick unit moves upward, a down directional key signal is generated when sensing that the stick unit moves downward, a left directional key signal is generated when sensing that the stick unit moves to the left, and a right directional key signal is generated when sensing that the stick unit moves to the right.

18. The input device of claim 17, wherein in (d), in a search mode in which a current item is activated, a previous item in the same category as the current item is activated when the up directional key signal is input, a following item in the same category as the current item is activated when the down directional key signal is input, a parent category including the current item is activated when the left directional key signal is input, and a sub category included in the current item is activated when the right directional key signal is input.

19. The input method of claim 17, wherein in (d), in a search mode in which a current item is activated, previous items in the same category as the current item are sequentially activated when the up directional key signal is continuously input, following items in the same category as the current item are sequentially activated when the down directional key signal is continuously input, and parent categories of the current item are sequentially activated when the left directional key signal is continuously input.

20. The input method of claim 17, wherein in (d), in a search mode in which a current song is activated, a previous song in the same category as the current song is activated when the up directional key signal is input, a following song in the same category as the current song is activated when the down directional key signal is input, a parent category including the current song is activated when the left directional key signal is input, and the current song is played when the right directional key signal is input.

21. The input method of claim 17, wherein in (d), in a search mode in which a current song is activated, previous songs in the same category as the current song are sequentially activated when the up directional key signal is continuously input, following songs in the same category as the current song are sequentially activated when the down directional key signal is continuously input, and parent categories of the current song are sequentially activated when the left directional key signal is continuously input.

22. The input method of claim 17, wherein in (d), in a search mode in which a current song is played, songs in a category including the current song are displayed when the up directional key signal is input, playback of the current song is stopped when the down directional key signal is input, playback of a previous song in the same category as the current song is started when the left directional key signal is input, and playback of a following song in the same category as the current song is started when the right directional key signal is input.

23. The input method of claim 22, wherein in (d), in a search mode in which a current song is played, a rewind operation of the current song is performed when the left directional key signal is continuously input, and a fast forward operation of the current song is performed when the right directional key signal is continuously input.

24. The input method of any one of claims 14, further comprising (e) displaying information on operations performed according to the directional key signals.

25. A computer-readable medium having embodied thereon a computer program for the method of claim 14.
